(19) United States
(12) Patent Application Publication
(10) Pub. No.: US 2025/0142143 A1
(43) Pub. Date: May 1, 2025

(54) MEDIA DEVICE WITH PICTURE QUALITY ENHANCEMENT FEATURE

(71) Applicant: Roku, Inc., San Jose, CA (US)

(72) Inventors: JUHI CHECKER, Sunnyvale, CA (US); Sharada Palasamudram Ashok Kumar, San Jose, CA (US); Erwin Bellers, Fremont, CA (US); Dengzhi Zhang, San Jose, CA (US); Weiming Zhang, San Jose, CA (US); Kunlung Wu, San Jose, CA (US); Chih-Kai Chang, Taipei City (TW); Johan Janssen, Morgan Hills, CA (US); Yong Li, Fremont, CA (US); Hsiang Yao Shih, Chupei (TW); Kung-Ho Lee, New Taipei City (TW)

(21) Appl. No.: 18/499,931

(22) Filed: Nov. 1, 2023

(51) Int. Cl. H04N 21/2343; G06N 3/0464

(52) U.S. Cl. CPC H04N 21/2343; G06N 3/0464; H04L 65/765

(57) ABSTRACT

Disclosed herein are system, method and/or computer program product embodiments, and/or combinations and sub-combinations thereof, for enhancing a picture quality of visual content rendered for display by a media device. In an embodiment, the media device reconstructs a video frame from a video signal that is received by the media device, provides the video frame as input to a machine learning model that outputs a set of picture quality parameter values based on the video frame, receives the set of picture quality parameter values output by the machine learning model, modifies the video frame based on the set of picture quality parameter values to generate a modified video frame, and provides the modified video frame to a display device for presentation thereby.

### BACKGROUND

### Field

This disclosure is generally directed to techniques for improving a picture quality of visual content presented for display by a media device.

### SUMMARY

Provided herein are system, apparatus, article of manufacture, method and/or computer program product embodiments, and/or combinations and sub-combinations thereof, for enhancing a picture quality of visual content rendered for display by a media device. In an example embodiment, the media device reconstructs a video frame from a video signal that is received by the media device, provides the video frame as input to a machine learning model that outputs a set of picture quality parameter values based on the video frame, receives the set of picture quality parameter values output by the machine learning model, modifies the video frame based on the set of picture quality parameter values to generate a modified video frame, and provides the modified video frame to a display device for presentation thereby.

In some aspects, the media device reconstructs the video frame from the video signal by performing one of reconstructing the video frame from an encoded video signal received via a network, reconstructing the video frame from a video signal received via a wired display interface, or reconstructing the video frame from an encoded video signal read from a computer-readable storage medium.

In some aspects, the media device provides the video frame as input to the machine learning model by providing the video frame as input to a convolutional neural network.

In some aspects, the media device provides the video frame as input to the machine learning model by providing the video frame as input to a machine learning model executing on the media device. For example, the media device may provide the video frame as input to a machine learning model executing on a neural processing unit of the media device.

In some aspects, the media device provides the video frame as input to the machine learning model by providing, via a network, the video frame as input to a machine learning model that is executing on a remote device.

In some aspects, the media device receives the set of picture quality parameter values by receiving one or more of a value corresponding to a sharpness parameter, a value corresponding to a saturation parameter, a value corresponding to a color parameter, a value corresponding to a tint parameter, a value corresponding to a brightness parameter, a value corresponding to a contrast parameter, a value corresponding to a noise reduction parameter, a value corresponding to a local dimming parameter, a value corresponding to a super resolution strength parameter, or a value corresponding to a picture mode parameter.

In some aspects, the media device receives the set of picture quality parameter values by receiving one or more of a value corresponding to a picture quality parameter to be applied to an entirety of the video frame, or a value corresponding to a picture quality parameter to be applied to a portion of the video frame.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a media device, according to some embodiments.

FIG. 3 illustrates a block diagram of a picture quality enhancement module of a media device, according to some embodiments.

FIG. 4 illustrates a flow diagram of a method performed by a media device for enhancing a picture quality of visual content rendered for display by the media device, according to some embodiments.

FIG. 5 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Televisions, monitors, and other display devices may provide various user-configurable settings that enable a user to adjust a picture quality associated with visual content (e.g., video or images) presented on a screen of the display device. For example, a television may provide settings for contrast, brightness, sharpness, color, tint, color temperature, or the like and a user may adjust such settings to achieve a desired picture quality.

Different types of visual content may benefit from different types of picture quality adjustments. For example, for an outdoor scene, it may be deemed desirable to boost color saturation to render the scene more vivid and intense. However, for a scene focused on a human face, increasing the color saturation can make the face seem too colorful and therefore unnatural. Likewise, for a scene focused on a human face, it may be deemed desirable to reduce sharpness so that various imperfections in the face will not be visible. However, reducing the sharpness of an outdoor scene may be deemed undesirable as details of the scene may be rendered too blurry.

To address the issue of different visual content benefitting from different configurations of display settings, some televisions provide a menu of user-selectable picture modes with names such as “vivid”, “natural”, “sports”, and “cinema”. When a user selects one of these modes, certain display settings (e.g., brightness, contrast, sharpness, and/or color temperature) are automatically adjusted to preset values. While this feature can help a user implement a set of display setting values that are well suited to a particular type of visual content, it may be problematic in that it requires the user to change the picture mode every time the user switches from watching one type of content to another (e.g., when switching from watching a movie to watching a sporting event). In addition, a content item may include a mix of different types of scenes (e.g., nature scenes, urban scenes, scenes with faces, etc.) so that no single picture mode is adequate for viewing the content item. Furthermore, not all visual content can be neatly classified into the relatively small number of categories encompassed by the picture modes. For visual content that does not fit neatly into a particular category, there may be no ideal picture mode.

Embodiments described herein may address some or all of the foregoing issues relating to enhancing a picture quality associated with visual content presented to a screen of a display device. For example, in embodiments, a media device receives a video signal and reconstructs a video frame therefrom. The media device then provides the video frame as input to a machine learning model that outputs a set of picture quality parameter values based on the video frame. The media device further receives the set of picture quality parameter values output by the machine learning model, modifies the video frame based on the set of picture quality parameter values to generate a modified video frame, and provides the modified video frame to a display device for presentation thereby.

Among other features and advantages, embodiments described herein may enable a media device to automatically adjust a picture quality associated with visual content being rendered thereby such that a desired picture quality may be achieved without requiring an end user to adjust the settings of a display device to which the visual content is being presented.

Furthermore, in certain embodiments, the media device may be capable of adjusting the picture quality of video content on a frame-by-frame basis so that the nature of the picture quality enhancement can be tailored to each individual frame of the video content. This may be especially beneficial when the subject matter of the visual content is rapidly changing.

Additionally, in certain embodiments, a machine learning model (e.g., a convolutional neural network) may be used to determine the picture quality parameter values to be applied to a particular video frame or image. Such machine learning model may be trained on a rich set of video frames/images and associated picture quality parameter settings to enable the model to select picture quality parameter values with a high degree of accuracy for all sorts of visual content types.

Also, in certain embodiments, the processing of visual content to determine an associated set of picture quality parameter values may be performed by a machine learning model or other algorithm that is executing on the media device itself as opposed to on a remote (e.g., cloud-based) server. Implementing such processing on the media device as opposed to on a remote server may be beneficial for a number of reasons, including an ability to leverage an already existing pipeline for rendering visual content on the media device, avoiding lag and computing resource consumption associated with network communication, and protecting user privacy by avoiding transmission of visual content being viewed by the user to an external entity.

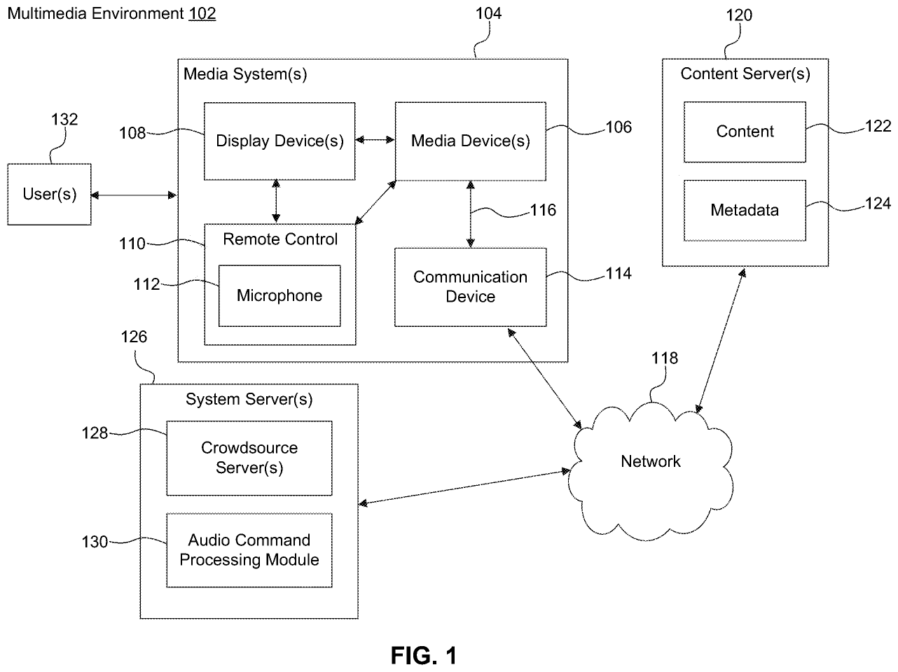

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. Communication device 114 may include, for example, a cable modem or satellite TV transceiver. Media device 106 may communicate with communication device 114 over a link 116, wherein link 116 may include wireless (such as Wi-Fi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106 and/or display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106 and/or display device 108 using cellular, Bluetooth, infrared, etc., or any combination thereof. Remote control 110 may include a microphone 112, which is further described below.

Multimedia environment 102 may include a plurality of content servers 120 (also called content providers, channels or sources 120). Although only one content server 120 is shown in FIG. 1, in practice multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to content 122. Metadata 124 may also or alternatively include one or more indexes of content 122.

Multimedia environment 102 may include one or more system servers 126. System servers 126 may operate to support media devices 106 from the cloud. It is noted that the structural and functional aspects of system servers 126 may wholly or partially exist in the same or different ones of system servers 126.

Media devices 106 may exist in thousands or millions of media systems 104. Accordingly, media devices 106 may lend themselves to crowdsourcing embodiments and, thus, system servers 126 may include one or more crowdsource servers 128.

For example, using information received from media devices 106 in the thousands and millions of media systems 104, crowdsource server(s) 128 may identify similarities and overlaps between closed captioning requests issued by different users 132 watching a particular movie. Based on such information, crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, crowdsource server(s) 128 may operate to cause closed captioning to be automatically turned on and/or off during future streamings of the movie.

System servers 126 may also include an audio command processing module 130. As noted above, remote control 110 may include microphone 112. Microphone 112 may receive audio data from users 132 (as well as other sources, such as the display device 108). In some embodiments, media device 106 may be audio responsive, and the audio data may represent verbal commands from user 132 to control media device 106 as well as other components in media system 104, such as display device 108.

In some embodiments, the audio data received by microphone 112 in remote control 110 is transferred to media device 106, which is then forwarded to audio command processing module 130 in system servers 126. Audio command processing module 130 may operate to process and analyze the received audio data to recognize user 132's verbal command. Audio command processing module 130 may then forward the verbal command back to media device 106 for processing.

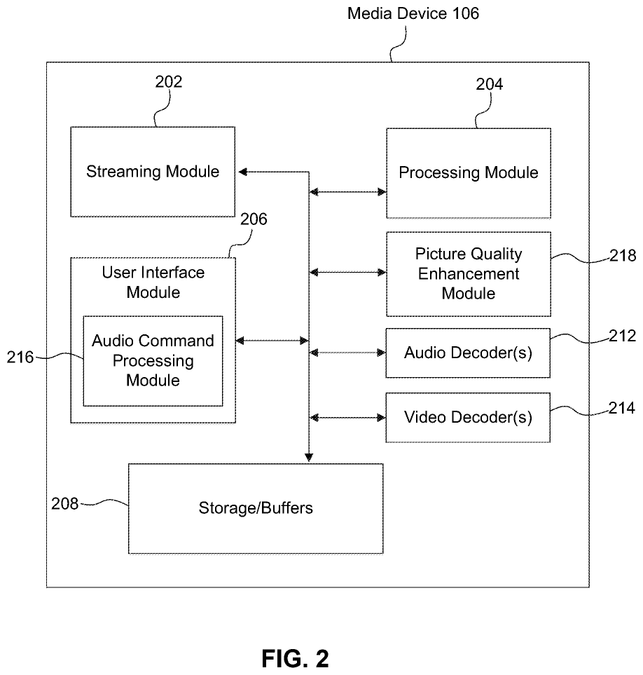

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

FIG. 2 illustrates a block diagram of an example media device 106, according to some embodiments. Media device 106 may include a streaming module 202, a processing module 204, storage/buffers 208, a user interface module 206, and a picture quality enhancement module 218. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. For example, user 132 may use remote control 110 to interact with user interface module 206 of media device 106 to select a content item, such as a movie, TV show, music, book, application, game, etc. In response to the user selection, streaming module 202 of media device 106 may request the selected content item from content server(s) 120 over network 118. Content server(s) 120 may transmit the requested content item to streaming module 202. Media device 106 may transmit the received content item to display device 108 for playback to user 132.

In streaming embodiments, streaming module 202 may transmit the content item to display device 108 in real time or near real time as it receives such content item from content server(s) 120. In non-streaming embodiments, media device 106 may store the content item received from content server(s) 120 in storage/buffers 208 for later playback on display device 108.

### Context Classification of Streaming Content Using Machine Learning

As further shown in FIG. 2, media device 106 may include a picture quality enhancement module 218. Picture quality enhancement module 218 may be configured to analyze visual content rendered by media device 106 to determine a set of picture quality parameter values for such visual content. As will be discussed herein, picture quality enhancement module 218 may include a machine learning model that predicts a set of picture quality parameter values for individual video frames or images rendered by media device 106. Picture quality enhancement module 218 may be further configured to apply the determined set of picture quality parameter values to the visual content for which such values were obtained to produce modified visual content and to provide such modified visual content to display device 108 for presentation thereby.

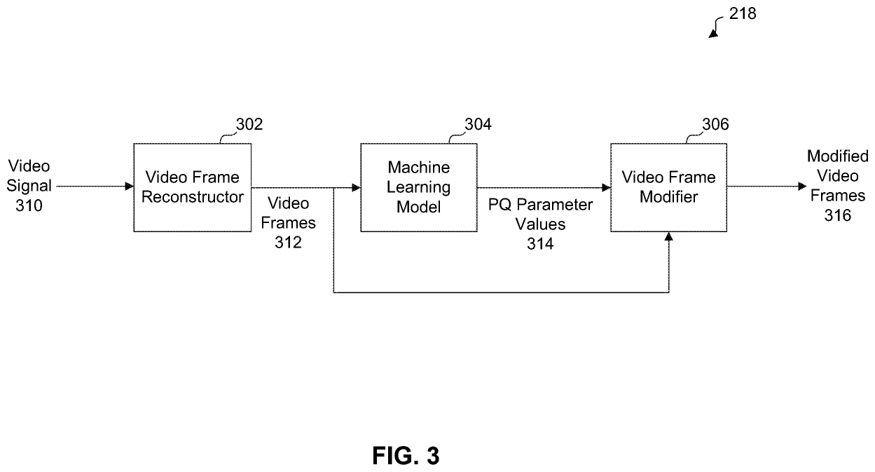

FIG. 3 illustrates a block diagram of picture quality enhancement module 218, according to some embodiments. As shown in FIG. 3, picture quality enhancement module 218 may comprise a video frame reconstructor 302, a machine learning model 304, and a video frame modifier 306. Each of these components may be implemented by processing logic that can comprise hardware (e.g., circuitry, dedicated logic, programmable logic, microcode, etc.), software (e.g., instructions executing on a processing device), or a combination thereof. Each of these components will now be described.

Media device 106 may receive a video signal 310 that represents visual content to be rendered by media device 106 for presentation by display device 108. For example, video signal 310 may represent an encoded video signal received via network 118 as part of an audio/video (A/V) stream that represents an item of content (e.g., a movie, TV show, or advertisement) to be played back by media device 106. The A/V stream may comprise, for example, a series of packets that carry encoded audio and video information associated with the item of content. The A/V stream, and thus video signal 310, may be transmitted to media device 106, for example, from content server(s) 120.

Alternatively, video signal 310 may be received via a wired display interface from another media device that is local with respect to media device 106. For example, video signal 310 may represent a High-Definition Multimedia Interface (HDMI) signal that is received via an HDMI cable from another media device that is local with respect to media device 106. However, this is merely one example, and video signal 310 may be received via other wired display interfaces including, but by no means limited to, mini HDMI, micro HDMI, VGA, mini-VGA, DisplayPort, Mini DisplayPort, DVI-D, DVI-I, mini-DVI, micro-DVI, USB Type-C or Thunderbolt. Video signal 310 may also be received via a wireless interface from another media device that is local with respect to media device 106 and is connected thereto via a suitable wireless communication link.

Still further, video signal 310 may represent a video signal that is encoded on a computer-readable storage medium and read therefrom by media device 106. For example, video signal 310 may be stored as encoded data on a floppy disk, magnetic tape, compact disk, DVD, optical storage disk, thumb drive, and/any other computer data storage device, and read therefrom by media device 106.

Video frame reconstructor 302 may be configured to transform video signal 310 into a corresponding sequence of video frames 312. Each video frame of video frames 312 may comprise an image in a sequence of images that make up an item of video content. Transforming video signal 302 into video frames 312 may comprise, for example, decoding video signal 302 utilizing a suitable one of video decoder(s) 214. Transforming video signal 302 into video frames 312 may also coprise, for example, decrypting video signal 302. Video frame reconstructor 302 may temporarily store video frames 312 in storage/buffers 208 of media device 106.

Video frames 312 may be provided to machine learning model 304 for processing thereby. Machine learning model 304 may be configured to receive each video frame of video frames 312 as an input and, for each video frame so received, output a corresponding set of picture quality (PQ) parameter values, thereby generating PQ parameter values 314. In certain implementations, not all video frames 312 are provided to machine learning model 304 to generate PQ parameter values 314. For example, a subsampled set of video frames 312 may be provided to machine learning model 304 to generate corresponding sets of PQ parameter values 314. Furthermore, each video frame that is provided to machine learning model 304 may comprise a downscaled representation of a video frame. In an alternate implementation, machine learning model 304 may be configured to receive multiple video frames 312 as input and to generate the set of PQ parameter values 314 based on the multiple video frames.

Machine learning model 304 may comprise, for example and without limitation, a convolutional neural network (CNN). In further accordance with such an example, machine learning model 304 may comprise a CNN having an architecture based on the MobileNet architecture or the Residual Network (ResNet) architecture. However, these are only examples and any other CNN architecture may be used, including but not limited to the LeNet architecture, the AlexNet architecture, the ZFNet architecture, the VGGNet architecture, the GoogLeNet architecture, or any other suitable CNN architecture whether previously known or hereinafter developed. Furthermore, machine learning model 304 may comprise other types of neural networks, such as a graph neural network or a capsule neural network, or other types of machine learning models.

Providing a video frame to machine learning model 304 may include preprocessing the video frame so that it is in a form suitable for processing by machine learning model 304. Such preprocessing may include, for example, and without limitation, resizing the video frame, changing a resolution of the video frame, converting pixels of the video frame into floating-point tensors, and optionally rescaling such pixel values.

PQ parameter values 314 predicted by machine learning model 304 for a particular video frame may comprise one or more of the following: a value corresponding to a sharpness parameter; a value corresponding to a saturation (or color level) parameter; a value corresponding to a color parameter, including but not limited to a color tone parameter, a color temperature parameter, a red parameter, a green parameter, or a blue parameter; a value corresponding to a tint (or hue) parameter; a value corresponding to a brightness (or black level) parameter; a value corresponding to a contrast (or white level) parameter; a value corresponding to a noise reduction parameter, including but not limited to a temporal noise reduction parameter, a spatial noise reduction parameter, or a digital noise reduction parameter; a value corresponding to a local dimming parameter; or a value corresponding to a super resolution parameter. However, these are merely examples. Persons skilled in the relevant art(s) will appreciate that machine learning model 304 may be configured to predict values associated with any parameter that may be used to adjust a picture quality of visual content whether or not such parameter is explicitly described herein.

A value associated with a PQ parameter output by machine learning model 304 may comprise a value in a range of possible values that indicate a relative strength or degree to which a PQ feature should be applied. Alternatively, a value associated with a PQ parameter may comprise a value that indicates whether a PQ feature should be turned on or off. For example, a value associated with a noise reduction parameter may be a value selected from a range of values that indicates a relative degree to which noise reduction should be applied or may be a value that indicates whether a noise reduction feature should be turned on or off. Likewise, a value associated with a local dimming parameter may be a value selected from a range of values that indicates a relative degree to which a local dimming feature should be applied or may be a value that indicates whether a local dimming feature should be turned on or off. Still further, a value associated with a super resolution parameter may be a value selected from a range of values that indicates a relative degree to which a super resolution feature should be applied or may be a value that indicates whether a local dimming feature should be turned on or off.

A value associated with a PQ parameter output by machine learning model 304 may comprise a value corresponding to a PQ parameter to be applied to an entirety of a video frame. For example, machine learning model 304 may output a sharpness value that is to be applied to an entirety of a video frame. Alternatively, a value associated with a PQ parameter output by machine learning model 304 may comprise a value corresponding to a PQ parameter to be applied to only a portion of a video frame. For example, machine learning model 304 may output a sharpness value to be applied only to fine details in a video frame, a sharpness value to be applied only to strong edges in a video frame, or a sharpness value to be applied only in certain parts of a frequency spectrum of a video frame.

A value associated with a PQ parameter output by a machine learning model 304 may comprise a picture mode value that may then be used to determine a particular set of PQ parameter values that should be applied to a video frame. For example, the picture mode value may be one of cinema/movie, standard, dynamic/vivid, sports, gaming, or the like, and this value may in turn be used to determine a particular set of PQ parameter values (e.g., values for brightness, contrast, sharpness, and/or color temperature) to be applied to a video frame.

Machine learning model 304 may be trained on a set of video frames or images and, for each video frame/image in the set, a set of labels comprising a set of desired or target PQ parameter values for the video frame/image. The training dataset may be relatively large in size and rich in image variety to enable machine learning model 304 to select PQ parameter values with a high degree of accuracy for all sorts of visual content types.

Machine learning model 304 may be stored and executed on media device 106. For example, machine learning model 304 may be part of picture quality enhancement module 218 which is executed on media device 106. In certain implementations, media device 106 may comprise a neural processing unit (NPU) upon which machine learning model 304 is executed. Alternatively, machine learning model 304 may execute on a graphics processing unit (GPU) of media device 106, a central processing unit (CPU) of media device 106, or other processing device or hardware of media device 106.

Machine learning model 304 may also be stored and executed on a device that is remote with respect to media device 106. For example, machine learning model 304 may be stored and executed on system server(s) 126 as described above in reference to FIG. 1. In accordance with such an implementation, picture quality enhancement module 218 of media device 106 may provide video frames 312 as input to machine learning model 304 by transmitting such frames via network 118 to system server(s) 126. In further accordance with such an implementation, system server(s) 126 may provide PQ parameter values 314 output by machine learning model 304 to picture quality enhancement module 218 of media device 106 by transmitting such PQ parameter values 314 thereto via network 118.

Although both implementations are viable, implementing machine learning model 304 on media device 106 as opposed to on remote system server(s) 126 may be considered preferable for a number of reasons, including an ability to leverage an already existing pipeline for rendering visual content on media device 106, avoiding lag and computing resource consumption associated with conducting communication over network 118, and/or protecting user privacy by avoiding transmission of visual content being viewed by the user to an external entity.

PQ parameter values 314 output by machine learning model may be provided to video frame modifier 306. As shown in FIG. 3, video frame modifier 306 also receives video frames 312 for which such values were selected. Video frame modifier 306 modifies each video frame in video frames 312 based on the corresponding set of PQ parameter values 314 generated therefor by machine learning model 304 to generate a sequence of modified video frames 316. For example, based on PQ parameter values 314 for a particular video frame, video frame modifier 306 may adjust (e.g., raise, lower, strengthen, weaken, turn on, turn off) a corresponding set of PQ parameters associated with the video frame. A list of various PQ parameter types was provided above and thus will not be repeated here for the sake of brevity. Modified video frames 316 generated by video frame modifier 306 may be provided to a display device, such as display device 108, for presentation thereby.

In certain implementations, machine learning model 304 may be utilized to generate a unique set of PQ parameter values 314 for each frame in sequence of video frames 312. However, in other implementations, machine learning model 304 may be utilized to generate a single set of PQ parameter values 314 to be applied to multiple video frames in sequence of video frames 312. For example, picture quality enhancement module 218 may determine that a particular video frame meets or exceeds a threshold level of similarity with respect to a preceding video frame, and thus that the PQ parameter values associated with the preceding video frame should also be applied to the particular video frame without having to provide the particular video frame to machine learning model 304. This may be the case, for example, when a scene is relatively static such that the subject matter of the video frames that make up the scene is not changing or is changing very slowly. Such an approach may reduce the utilization of machine learning model 304, thereby conserving computing resources.

The foregoing description of picture quality enhancement module 218 refers to determining PQ parameter values for video frames in a sequence of video frames and applying the determined PQ parameter values thereto. However, it is noted that the above-described techniques may also be applied to other types of visual content that may be rendered by media device 106 as well to improve a picture quality thereof, including static images, graphical user interface (GUI) screens, or the like.

Furthermore, although the foregoing refers to the use of machine learning model 304 to determine PQ parameter values 314 for a given video frame or image, it is possible that other algorithms or approaches may be utilized to determine such PQ parameter values 314. For example, an algorithm may be used that determines PQ parameter values 314 based on hand-coded heuristics such as whether certain features (e.g., skin color) are present or absent in a video frame or image. As another example, a machine learning classifier may be used to classify a video frame or image with respect to a predefined number of scene types and then the output of the machine learning classifier may be provided to a decision tree that outputs a set of PQ parameter values based thereon. However, the approach of using a machine learning model may be deemed preferable to a heuristic-based approach since training the model on actual image data and PQ parameter settings may produce more accurate and reliable output. Furthermore, using a single machine learning model (e.g., a CNN) to produce the PQ parameter values may be deemed easier and more efficient to implement as compared to using a combination of a machine learning classifier and decision tree, each of which must be independently developed, tuned, and maintained.

In a further implementation, machine learning model 304 may be configured to also determine a set of audio quality parameter values based on one or more video frames 312. For example, based on one or more video frames 312, machine learning model 304 may determine values associated with one or more of the following audio quality parameters: volume, balance, bass, treble, mid, surround, audio language, or audio mode. Media device 106 may then apply the determined audio quality parameter values to an audio track or audio stream associated with the content represented by video frames 312 to generate a modified audio track or audio stream. Such a feature may be used, for example, to automatically enhance sound clarity for a news scene, or other scene where it may be expected that a person is speaking. However, this is merely one example and is not intended to be limiting. In an alternative implementation, media device 106 may utilize two machine learning models-one that generates picture quality parameter values based on video frames and another that generates audio quality parameter values based on audio frames.

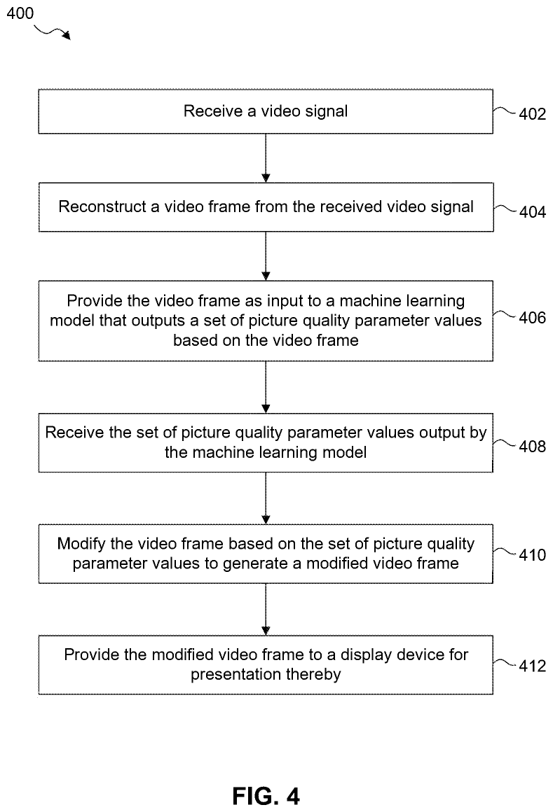

FIG. 4 is a flow diagram for a method 400 performed by a media device for enhancing a picture quality of visual content rendered for display by the media device, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to media device 106 of FIGS. 1-3, which is one example of a media device, although method 400 is not limited to that embodiment.

In 402, picture quality enhancement module 218 of media client 106 receives video signal 310. Video signal 310 may comprise, for example, an encoded video signal received via a network (e.g., network 118) from a remote device (e.g., content server(s) 120), a video signal received via a wired display interface (e.g., HDMI) from another media device that is local with respect to media device 106, or an encoded video signal that is read by media device 106 from a computer-readable storage medium.

In 404, video frame reconstructor 302 of picture quality enhancement module 218 reconstructs a video frame 312 from the received video signal 402. Reconstructing video frame 312 from video signal 310 may comprise decoding video signal 310 using a suitable video decoder 214.

In 406, picture quality enhancement module 218 provides video frame 312 as input to machine learning model 304 that outputs a set of PQ parameter values 314 based on video frame 312. Providing video frame 312 as input to machine learning model 304 may comprise providing video frame 312 as input to a convolutional neural network. Providing video frame 312 as input to machine learning model 304 may also comprise providing video frame 312 as input to machine learning model 304 executing on media device 306. In further accordance with such an implementation, providing video frame 312 as input to machine learning model 304 executing on media device 306 may comprise providing video frame 312 as input to machine learning model executing on an NPU, a GPU or a CPU of media device 106. In an alternative implementation, providing video frame 312 as input to machine learning model 304 may comprise providing, via a network (e.g., network 118), video frame 312 as input to machine learning model 304 that is executing on a remote device (e.g., system server(s) 126).

It is noted that machine learning model 304 may be configured to receive multiple video frames as input and to generate the set of PQ parameter values 314 based on the multiple video frames. In such an implementation, 406 may entail providing video frame 312, and one or more additional video frames, as input to machine learning model 304.

In 408, video frame modifier 306 of picture quality enhancement module 218 receives the set of PQ parameter values 314 from machine learning model 304. Receiving the set of PQ parameter values 314 from machine learning model 304 may comprise receiving the set of PQ parameter values 314 from machine learning model 304 that is executing on media device 106 or receiving the set of PQ parameter values 314 from machine learning model 304 that is executing on a remote device via a network (e.g., network 118).

Receiving the set of picture quality parameters in 408 may comprise receiving one or more of: a value corresponding to a sharpness parameter; a value corresponding to a saturation (or color level) parameter; a value corresponding to a color parameter, including but not limited to a color tone parameter, a color temperature parameter, a red parameter, a green parameter, or a blue parameter; a value corresponding to a tint (or hue) parameter; a value corresponding to a brightness (or black level) parameter; a value corresponding to a contrast (or white level) parameter; a value corresponding to a noise reduction parameter, including but not limited to a temporal noise reduction parameter, a spatial noise reduction parameter, or a digital noise reduction parameter; a value corresponding to a local dimming parameter; or a value corresponding to a super resolution parameter.

Receiving the set of picture quality parameters in 408 may also comprise receiving one or more of: a value corresponding to a picture quality parameter to be applied to an entirety of the video frame; or a value corresponding to a picture quality parameter to be applied to a portion of the video frame

In 410, video frame modifier 306 modifies video frame 312 based on the set of PQ parameter values 314 to generate a modified video frame 316.

In 412, video frame modifier 306 provides modified video frame 316 to a display device (e.g., display device 108) for presentation thereby.

### Example Computer System

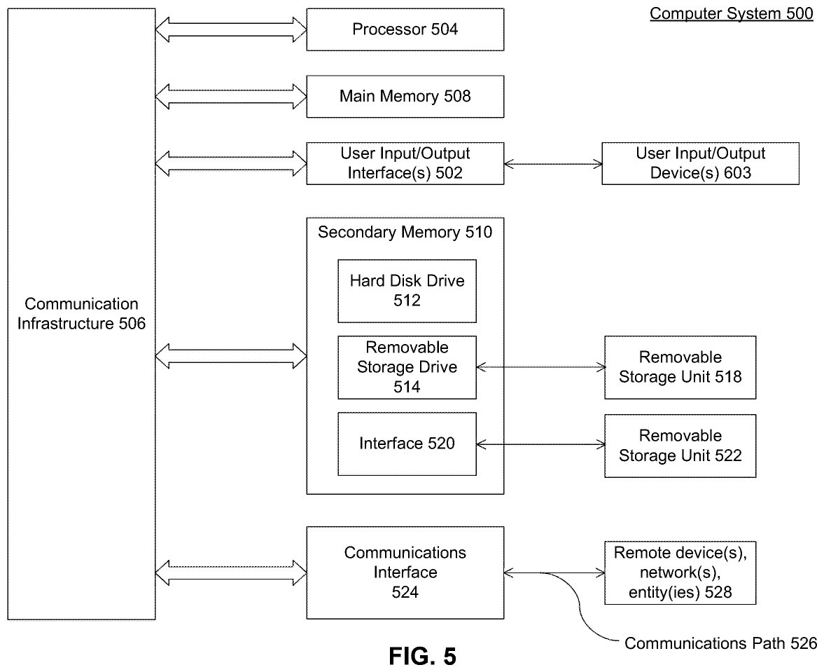

Various embodiments may be implemented, for example, using one or more well-known computer systems, such as computer system 500 shown in FIG. 5. For example, one or more of media device 106, remote control 110, content server(s) 120, system server(s) 126 or picture quality enhancement module 216 may be implemented using combinations or sub-combinations of computer system 500. Also or alternatively, one or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method performed by a media device, comprising:
reconstructing, by at least one computer processor of the media device, a video frame from a video signal that is received by the media device;
providing the video frame as input to a machine learning model that outputs a set of picture quality parameter values based on the video frame;
receiving the set of picture quality parameter values output by the machine learning model;
modifying the video frame based on the set of picture quality parameter values to generate a modified video frame; and
providing the modified video frame to a display device for presentation thereby.

2. The method of claim 1, wherein reconstructing the video frame from the video signal comprises one of:
reconstructing the video frame from an encoded video signal received via a network;
reconstructing the video frame from a video signal received via a wired display interface; or
reconstructing the video frame from an encoded video signal read from a computer-readable storage medium.

3. The method of claim 1, wherein providing the video frame as input to the machine learning model comprises:
providing the video frame as input to a convolutional neural network.

4. The method of claim 1, wherein providing the video frame as input to the machine learning model comprises:
providing the video frame as input to a machine learning model executing on the media device.

5. The method of claim 3, wherein providing the video frame as input to the machine learning model executing on the media device comprises:
providing the video frame as input to a machine learning model executing on a neural processing unit of the media device.

6. The method of claim 1, wherein providing the video frame as input to the machine learning model comprises:
providing, via a network, the video frame as input to a machine learning model that is executing on a remote device.

7. The method of claim 1, wherein receiving the set of picture quality parameter values comprises receiving one or more of:
a value corresponding to a sharpness parameter;
a value corresponding to a saturation parameter;
a value corresponding to a color parameter;
a value corresponding to a tint parameter;
a value corresponding to a brightness parameter;
a value corresponding to a contrast parameter;
a value corresponding to a noise reduction parameter;
a value corresponding to a local dimming parameter;
a value corresponding to a super resolution strength parameter;
a value corresponding to a picture mode parameter.

8. The method of claim 1, wherein receiving the set of picture quality parameter values comprises receiving one or more of:
a value corresponding to a picture quality parameter to be applied to an entirety of the video frame; or
a value corresponding to a picture quality parameter to be applied to a portion of the video frame.

9. A media device, comprising:
one or more memories; and
at least one processor each coupled to at least one of the memories and configured to perform operations comprising:
reconstructing a video frame from a video signal that is received by the media device;
providing the video frame as input to a machine learning model that outputs a set of picture quality parameter values based on the video frame;
receiving the set of picture quality parameter values output by the machine learning model;
modifying the video frame based on the set of picture quality parameter values to generate a modified video frame; and
providing the modified video frame to a display device for presentation thereby.

10. The media device of claim 9, wherein reconstructing the video frame from the video signal comprises one of:
reconstructing the video frame from an encoded video signal received via a network;
reconstructing the video frame from a video signal received via a wired display interface; or
reconstructing the video frame from an encoded video signal read from a computer-readable storage medium.

11. The media device of claim 9, wherein providing the video frame as input to the machine learning model comprises:
providing the video frame as input to a convolutional neural network.

12. The media device of claim 9, wherein providing the video frame as input to the machine learning model comprises:
providing the video frame as input to a machine learning model executing on the media device.

13. The media device of claim 12, wherein providing the video frame as input to the machine learning model executing on the media device comprises:
providing the video frame as input to a machine learning model executing on a neural processing unit of the media device.

14. The media device of claim 9, wherein providing the video frame as input to the machine learning model comprises:
providing, via a network, the video frame as input to a machine learning model that is executing on a remote device.

15. The media device of claim 9, wherein receiving the set of picture quality parameter values comprises receiving one or more of:
a value corresponding to a sharpness parameter;
a value corresponding to a saturation parameter;
a value corresponding to a color parameter;
a value corresponding to a tint parameter;
a value corresponding to a brightness parameter;
a value corresponding to a contrast parameter;
a value corresponding to a noise reduction parameter;
a value corresponding to a local dimming parameter;
a value corresponding to a super resolution strength parameter;
a value corresponding to a picture mode parameter.

16. The media device of claim 9, wherein receiving the set of picture quality parameter values comprises receiving one or more of:
a value corresponding to a picture quality parameter to be applied to an entirety of the video frame; or
a value corresponding to a picture quality parameter to be applied to a portion of the video frame.

17. A non-transitory computer-readable medium having instructions stored thereon that, when executed by at least one computer processor of a media device, causes the at least one computer processor to perform operations, the operations comprising:
reconstructing, by at least one computer processor of the media device, a video frame from a video signal that is received by the media device;
providing the video frame as input to a machine learning model that outputs a set of picture quality parameter values based on the video frame;
receiving the set of picture quality parameter values output by the machine learning model;
modifying the video frame based on the set of picture quality parameter values to generate a modified video frame; and
providing the modified video frame to a display device for presentation thereby.

18. The non-transitory computer-readable medium of claim 17, wherein providing the video frame as input to the machine learning model comprises:
providing the video frame as input to a convolutional neural network.

19. The non-transitory computer-readable medium of claim 17, wherein receiving the set of picture quality parameter values comprises receiving one or more of:
a value corresponding to a sharpness parameter;
a value corresponding to a saturation parameter;
a value corresponding to a color parameter;
a value corresponding to a tint parameter;
a value corresponding to a brightness parameter;
a value corresponding to a contrast parameter;
a value corresponding to a noise reduction parameter;
a value corresponding to a local dimming parameter;
a value corresponding to a super resolution strength parameter;
a value corresponding to a picture mode parameter.

20. The non-transitory computer-readable medium of claim 17, wherein receiving the set of picture quality parameter values comprises receiving one or more of:
a value corresponding to a picture quality parameter to be applied to an entirety of the video frame; or
a value corresponding to a picture quality parameter to be applied to a portion of the video frame.
